(19) United States
(12) Patent Application Publication
(10) Pub. No.: US 2025/0012740 A1
(43) Pub. Date: Jan. 9, 2025

(54) TRANSMISSION ELECTRON MICROSCOPE AND SAMPLE ANALYSIS METHOD USING TRANSMISSION ELECTRON MICROSCOPE

(71) Applicant: Kioxia Corporation, Tokyo (JP)

(72) Inventor: Takeshi OWAKI, Yokkaichi Mie (JP)

(73) Assignee: Kioxia Corporation, Tokyo (JP)

(21) Appl. No.: 18/758,615

(22) Filed: Jun. 28, 2024

(30) Foreign Application Priority Data
Jul. 3, 2023 (JP) 2023-109045

(51) Int. Cl. G01N 23/04; G01N 23/20058

(52) U.S. Cl. CPC G01N 23/04; G01N 23/20058; G01N 2223/401

(57) ABSTRACT

According to one embodiment, a transmission electron microscope includes an irradiation unit that is configured to irradiate a sample with a parallel electron beam at a predetermined incident angle, a sample holding unit that is configured to hold the sample, an aperture unit that is located downstream in a traveling direction of the electron beam transmitted the sample or scattered by the sample and that has an opening, an image forming lens that is located downstream in the traveling direction of the electron beam with respect to the opening of the aperture unit and that forms an image of the electron beam selected by the aperture unit, an image capturing unit that is located downstream in the traveling direction of the electron beam with respect to the image forming lens, that captures a bright-field image and a dark-field image formed by the image forming lens, and that has an imaging surface, and an analysis unit that analyzes the sample based on the bright-field image and the dark-field image.

### CROSS-REFERENCE TO RELATED APPLICATION(S)

This application is based upon and claims the benefit of priority from Japanese Patent Application No. 2023-109045, filed Jul. 3, 2023, the entire contents of which are incorporated herein by reference.

### FIELD

Embodiments described herein relate generally to a transmission electron microscope and a sample analysis method using a transmission electron microscope.

### BACKGROUND

In the transmission electron microscope, an electron beam is emitted from an irradiation unit including an electron gun. A sample transmits or scatters the emitted electron beam. The electron beam is imaged by an image capturing unit. An image obtained by the image capturing unit is used to analyze the sample.

### DESCRIPTION OF THE DRAWINGS

FIG. 1 is a schematic diagram of a transmission electron microscope according to an embodiment.

FIGS. 2A to 2D are schematic diagrams for illustrating an incident angle of an electron beam with respect to a sample in the embodiment.

FIG. 3 is a flowchart of a sample analysis method using a transmission electron microscope according to the embodiment.

FIGS. 4A to 4G are schematic diagrams showing an example of the sample analysis method using a transmission electron microscope according to the embodiment.

FIGS. 5A to 5G are schematic diagrams showing an example of the sample analysis method using a transmission electron microscope according to the embodiment.

FIGS. 6A to 6G are schematic diagrams showing an example of the sample analysis method using a transmission electron microscope according to the embodiment.

FIGS. 7A to 7G are schematic diagrams showing an example of the sample analysis method using a transmission electron microscope according to the embodiment.

FIGS. 8A to 8G are schematic diagrams showing an example of the sample analysis method using a transmission electron microscope according to the embodiment.

FIGS. 9A and 9B are schematic diagrams showing another example of the sample analysis method using the transmission electron microscope according to the embodiment.

FIGS. 10A and 10B are schematic diagrams showing another example of the sample analysis method using the transmission electron microscope according to the embodiment.

### DETAILED DESCRIPTION

Embodiments provide a transmission electron microscope and a sample analysis method using a transmission electron microscope, which can analyze a sample over a wide range and with high resolution.

In general, according to one embodiment, a transmission electron microscope includes an irradiation unit that is configured to irradiate a sample with a parallel electron beam at a predetermined incident angle, a sample holding unit that is configured to hold the sample, an aperture unit that is located downstream in a traveling direction of the electron beam transmitted from the sample or scattered by the sample and that has an opening, an image forming lens that is located downstream in the traveling direction of the electron beam with respect to the opening of the aperture unit and that forms an image of the electron beam selected by the aperture unit, an image capturing unit that is located downstream in the traveling direction of the electron beam with respect to the image forming lens, that captures a bright-field image and a dark-field image formed by the image forming lens, and that has an imaging surface, and an analysis unit that analyzes the sample based on the bright-field image and the dark-field image.

Hereinafter, embodiments will be described with reference to the accompanying drawings. In the drawings, the same or similar portions are denoted by the same or similar reference numerals.

In the present specification, in order to indicate a positional relationship of components and the like, an upper direction of a drawing is described as “up”, and a lower direction of the drawing is described as “down”. In the present specification, the concepts of “up” and “down” are not necessarily terms indicating a relationship with the direction of gravity and are not intended to be limiting.

### Embodiment

A transmission electron microscope according to the embodiment includes an irradiation unit that is configured to irradiate a sample with a parallel electron beam at a predetermined incident angle, a sample holding unit that is configured to hold the sample, an aperture unit that is located downstream in a traveling direction of the electron beam transmitted from the sample or scattered by the sample and that has an opening, an image forming lens that is located downstream in the traveling direction of the electron beam with respect to the opening of the aperture unit and that forms an image of the electron beam selected by the aperture unit, an image capturing unit that is located downstream in the traveling direction of the electron beam with respect to the image forming lens, that images a bright-field image and a dark-field image formed by the image forming lens, and that has an imaging surface, and an analysis unit that analyzes the sample based on the bright-field image and the dark-field image.

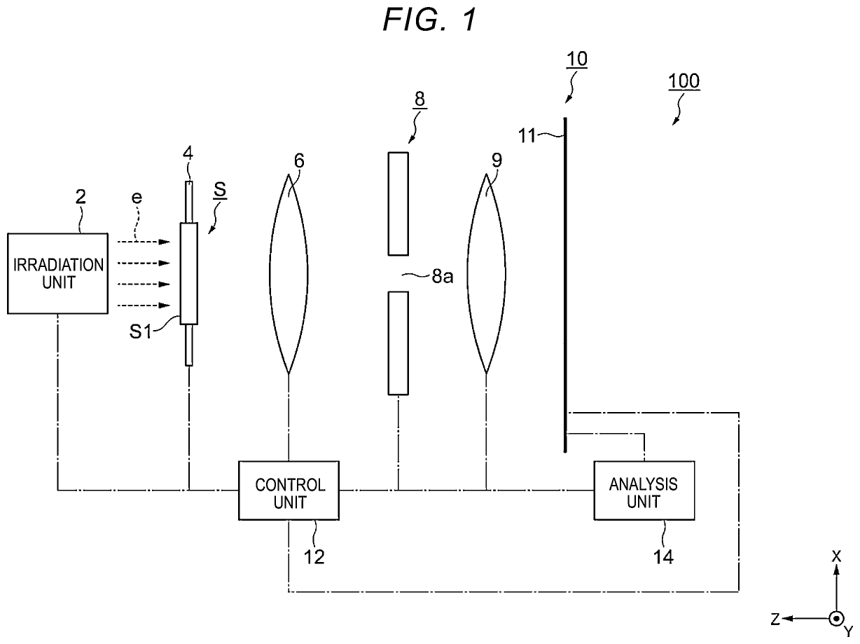

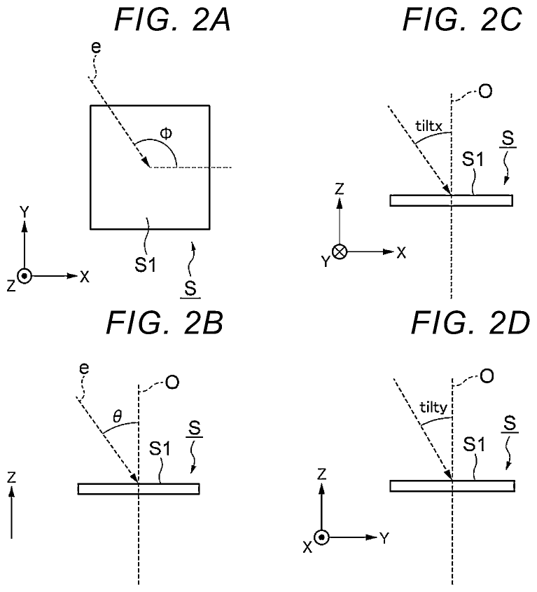

FIG. 1 is a schematic diagram of a transmission electron microscope 100 according to an embodiment. FIGS. 2A to 2D are schematic diagrams for illustrating an incident angle of an electron beam e with respect to a sample in the embodiment.

The transmission electron microscope 100 includes an irradiation unit (irradiator) 2, a sample holding unit 4, an objective lens 6, an aperture unit 8, an image forming lens 9, an image capturing unit 10, a control unit 12, and an analysis unit (analyzer) 14.

A sample S has a sample surface S1.

The image capturing unit 10 has an imaging surface 11.

The irradiation unit 2 has an electron gun (not shown). The electron gun emits the electron beam e. The irradiation unit 2 further includes, for example, a condenser lens (not shown). The condenser lens may form an electric field and a magnetic field that condense the electron beam e while maintaining a parallelism of the electron beam. The electron beam e emitted from the electron gun is made a parallel electron beam by the condenser lens. The condenser lens is, for example, an electromagnetic lens. The irradiation unit 2 may have a plurality of unillustrated condenser lenses in order to ensure a parallelism and a condensability of the electron beam e.

Here, an X direction, a Y direction that intersects perpendicularly to the X direction, and a Z direction that intersects perpendicularly to the X and Y directions are defined. The sample surface S1 of the sample S, the aperture unit 8, and the imaging surface 11 of the image capturing unit 10 are provided in a plane perpendicular to the Z direction. The sample surface S1 of the sample S, the aperture unit 8, and the imaging surface 11 of the image capturing unit 10 are provided parallel to an XY plane.

The electron beam e is incident on the sample surface S1 of the sample S at a predetermined incident angle by using the irradiation unit 2.

Here, a predetermined angle will be described. As shown in FIG. 2A, the electron beam e is incident on the sample surface S1 of the sample S at an angle φ with respect to the X direction in a plane parallel to the XY plane.

Further, as shown in FIG. 2B, the electron beam e is incident on the sample surface S1 of the sample S at an angle θ with respect to a −Z direction. This will be further described with reference to FIGS. 2C and 2D. As shown in FIG. 2C, the electron beam e is incident on the sample surface S1 of the sample S at an angle θx (tilt X) with respect to the −Z direction in a plane parallel to an XZ plane. Further, as shown in FIG. 2D, the electron beam e is incident on the sample surface S1 of the sample S at an angle θy (tilt Y) with respect to the −Z direction in a plane parallel to a YZ plane.

The angle φ, the angle θx (tilt X), and the angle θy (tilt Y) may be changed, for example, by using a deflector (polarizer) (not shown) of the irradiation unit 2.

In FIGS. 2B, 2C, and 2D, an optical axis O of the transmission electron microscope 100 is also shown. The optical axis O is parallel to, for example, the Z axis.

The sample S is held by the sample holding unit 4 such that the sample surface S1 is parallel to the XY plane.

The electron beam e transmitted the sample S or scattered by the sample S is formed into an image on the imaging surface 11 of the image capturing unit 10 by using the objective lens 6 and the aperture unit 8 located downstream in the traveling direction of the electron beam e. Here, a downstream in a traveling direction of the electron beam e is a side in the −Z direction.

The objective lens 6 is, for example, an electromagnetic lens.

The aperture unit 8 has a thickness that can shield the electron beam e in a direction parallel to the Z direction. The aperture unit 8 has an opening 8a. The electron beam e may pass through the opening 8a.

The image forming lens 9 has, for example, an electromagnetic lens. The image forming lens 9 may have a mechanism used for another image forming (not shown).

The image capturing unit 10 is, for example, a camera. Further, the imaging surface 11 is, for example, a surface on which an imaging element of a camera is provided. A bright-field image (bright-field imaging: BF image) or a dark-field image (dark-field imaging: DF image) of the sample S is formed on the imaging surface 11 by the aperture unit 8 and the image forming lens 9.

The image capturing unit 10 images the bright-field image and the dark-field image formed on the imaging surface 11.

Here, the bright-field image is an image obtained by forming an image of only the electron beam e transmitted from the sample S. The dark-field image is an image obtained by forming an image of only a specific electron beam e among the electron beams e scattered by the sample S.

The control unit 12 performs, for example, control of emission of the electron beam e from the electron gun of the irradiation unit 2, control of condensation of the electron beam e by the condenser lens of the irradiation unit 2, and control of an incident angle of the electron beam e to the sample S by the irradiation unit 2. The control unit 12 controls the focus of the bright-field image and the dark-field image by controlling, for example, the excitation amount of the objective lens 6. The control unit 12 controls, for example, the movement of the aperture unit 8 in the XY plane. The control unit 12 controls, for example, a size of the opening 8a of the aperture unit 8. The control unit 12 also controls, for example, an exposure time of the image capturing unit 10. The control unit 12 may also control, for example, a movement of the sample S using the sample holding unit 4 or an inclination of the sample S.

The analysis unit 14 analyzes the sample S based on the bright-field image and the dark-field image captured by the image capturing unit 10.

The control unit 12 and the analysis unit 14 are, for example, electronic circuits. The control unit 12 and the analysis unit 14 are, for example, a controller, a central processing unit that operates a program, a processor operates a program, or a computer configured with a combination of hardware such as an arithmetic circuit and software such as a program.

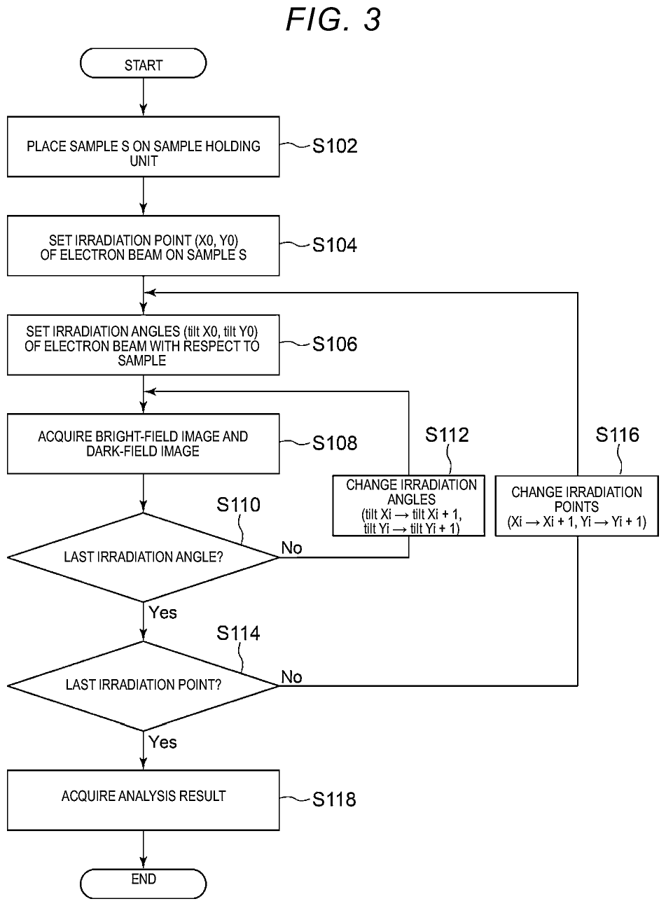

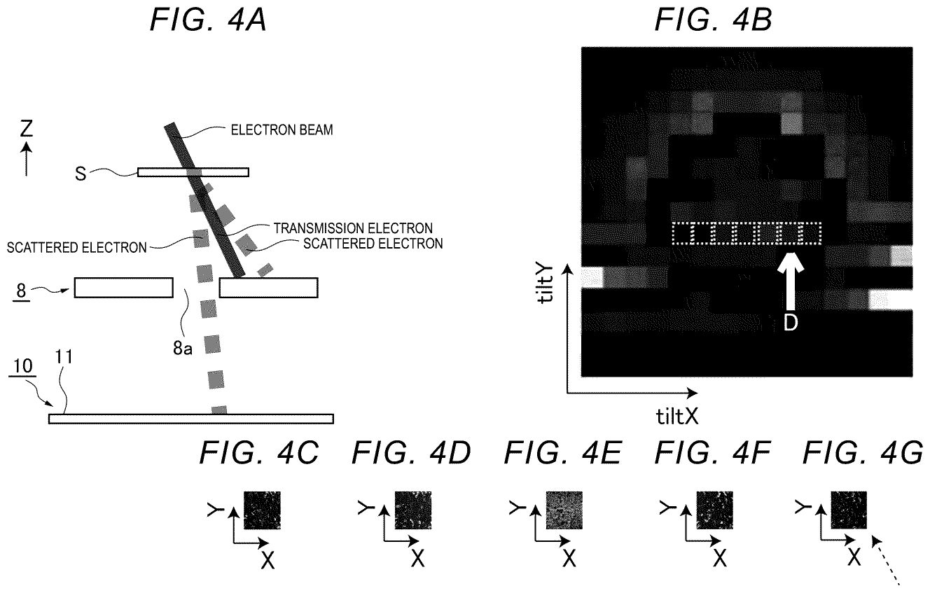

FIG. 3 is a flowchart of a sample analysis method using the transmission electron microscope 100 according to the embodiment. FIGS. 4A to 8G are schematic diagrams showing an example of a sample analysis method using the transmission electron microscope 100 according to the embodiment.

The sample analysis method using a transmission electron microscope according to the embodiment includes irradiating a sample with a parallel electron beam at a predetermined incident angle, forming an image of the electron beam selected by the aperture unit by an image forming lens, the aperture unit being located downstream in a traveling direction of the electron beam transmitted from the sample or scattered by the sample and having an opening, imaging a bright-field image and a dark-field image imaged by the image forming lens, and analyzing the sample based on the bright-field image and the dark-field image.

The sample analysis method using the transmission electron microscope 100 according to the embodiment will be described with reference to FIGS. 3 to 8G.

First, the sample S is placed on the sample holding unit 4 (S102 in FIG. 3).

Next, the control unit 12 sets an irradiation point of the electron beam on the sample S by controlling, for example, the irradiation unit 2 (S104 in FIG. 3). Here, the irradiation point is defined by, for example, an X coordinate (X0) and a Y coordinate (Y0) on the sample S. That is, the irradiation point is information indicating which irradiation point on the sample S is irradiated with the electron beam. For example, the control unit 12 and the irradiation unit 2 are used to bring the observation region, which is the irradiation point of the sample S, to the center of a field of view of the transmission electron microscope.

Next, the control unit 12 sets the irradiation angles (tilt X0 and tilt Y0) of the electron beam with respect to the set irradiation points (S106). Next, the control unit 12 acquires a bright-field image (BF image) and a dark-field image (DF image) using the image capturing unit 10 (S108).

Next, the control unit 12 determines whether the acquisition of the bright-field image (BF image) and the dark-field image (DF image) at the last irradiation angle at the irradiation point is completed (S110). When it is determined that the acquisition of the bright-field image (BF image) and the dark-field image (DF image) at the last irradiation angle is not completed (S110, No), a new irradiation angle (tilt X1 and tilt Y1) of the electron beam is set (S112). In other words, when the acquisition of the bright-field image (BF image) and the dark-field image (DF image) at the last irradiation angle is not completed, the irradiation angle of the electron beam is changed from the previous value (tilt Xi and tilt Yi) to the next value (tilt Xi+1 and tilt Yi+1). Then, a bright-field image (BF image) and a dark-field image (DF image) are acquired at the new irradiation angle (tilt X1 and tilt Y1) of the electron beam (S108).

When it is determined that the acquisition of the bright-field image (BF image) and the dark-field image (DF image) at the last irradiation angle is completed (S110, Yes), it is determined whether the acquisition of the bright-field image (BF image) and the dark-field image (DF image) at the last irradiation point is completed (S114). When it is determined that the acquisition of the bright-field image (BF image) and the dark-field image (DF image) at the last irradiation point is not completed (S114, No), new irradiation points (X1 and Y1) of the electron beam are set (S116). In other words, when the bright-field image (BF image) and the dark-field image (DF image) are not acquired at the last irradiation point, the irradiation position of the electron beam is changed from the previous value (Xi and Yi) to the next value (Xi+1 and Yi+1). Then, an irradiation angle (tilt X0 and tilt Y0) of the electron beam is set at the new irradiation points (X1 and Y1) of the electron beam (S106), and a bright-field image (BF image) and a dark-field image (DF image) are acquired (S108). Here, the change in the irradiation position of the electron beam is performed, for example, by moving the sample S using the control unit 12.

When it is determined that the acquisition of the bright-field image (BF image) and the dark-field image (DF image) at the last irradiation point is completed (S114, Yes), the analysis unit 14 analyzes the sample S based on the acquired bright-field image and dark-field image, and obtains an analysis result (S118). This analysis will be described below.

Here, FIGS. 4C, 5C, 6C, 7C, and 8C show the same images, respectively, for convenience. Further, FIGS. 4D, 5D, 6D, 7D, and 8D show the same images, respectively, for convenience. Further, FIGS. 4E, 5E, 6E, 7E, and 8E show the same images, respectively, for convenience. Further, FIGS. 4F, 5F, 6F, 7F, and 8F show the same images, respectively, for convenience. Further, FIGS. 4G, 5G, 6G, 7G, and 8G show the same images, respectively, for convenience.

For example, as shown in FIG. 4A, a case where the irradiation unit 2 and the aperture unit 8 are controlled to change the incident angle of the electron beam e, the electron beam e transmitted from the sample S is shielded by the aperture unit 8, and the electron beam e scattered by the sample S is imaged is considered. The captured image in this case is a dark-field image (DF image) shown in FIG. 4G.

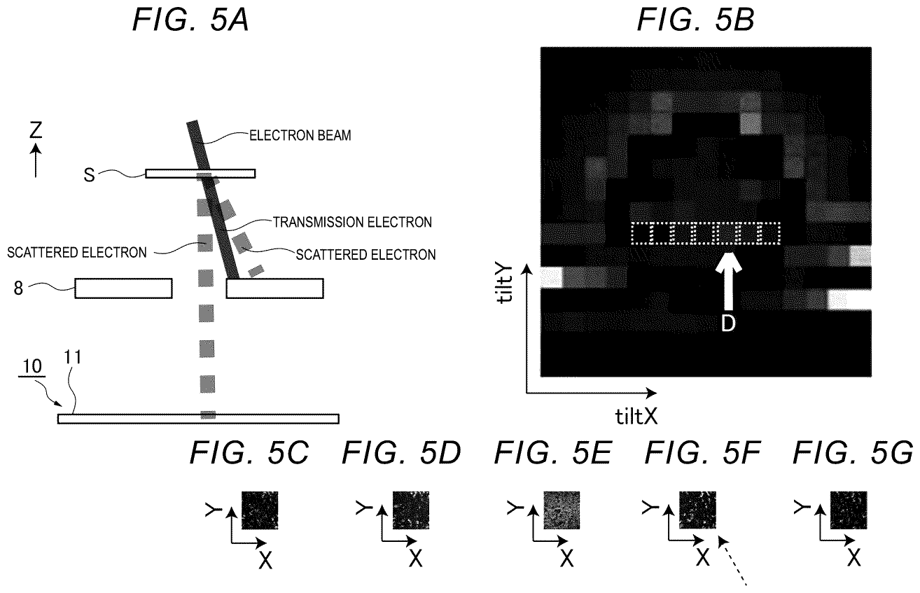

In addition, for example, as shown in FIG. 5A, a case where the irradiation unit 2 and the aperture unit 8 are controlled to change the incident angle of the electron beam e, the electron beam e transmitted from the sample S is shielded by the aperture unit 8, and the electron beam e scattered by the sample S is imaged is considered. The captured image in this case is a dark-field image (DF image) shown in FIG. 5F.

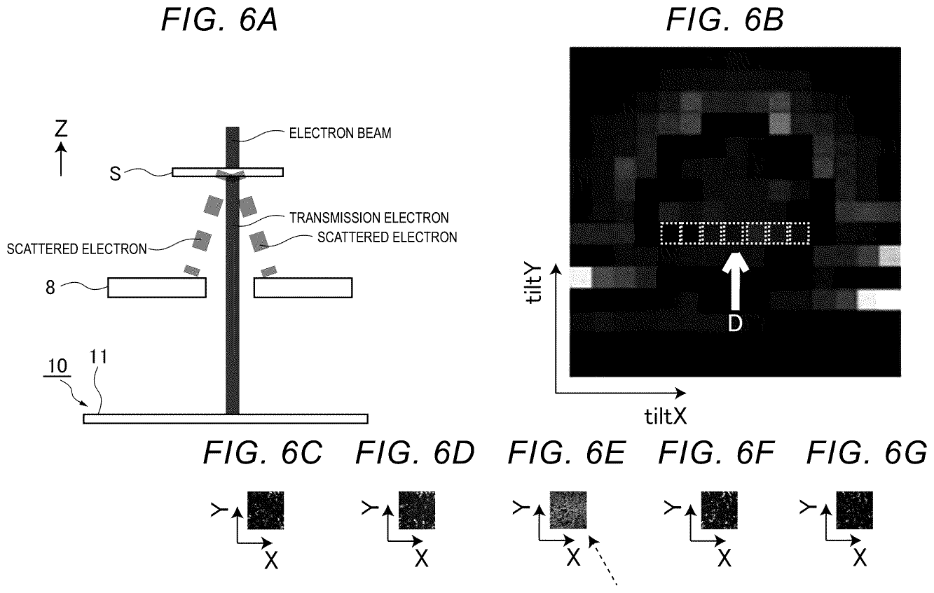

In addition, for example, as shown in FIG. 6A, a case where the irradiation unit 2 and the aperture unit 8 are controlled to change the incident angle of the electron beam e, the electron beam e scattered by the sample S is shielded by the aperture unit 8, and the electron beam e transmitted from the sample S is imaged is considered. The captured image in this case is a bright-field image (BF image) shown in FIG. 6E.

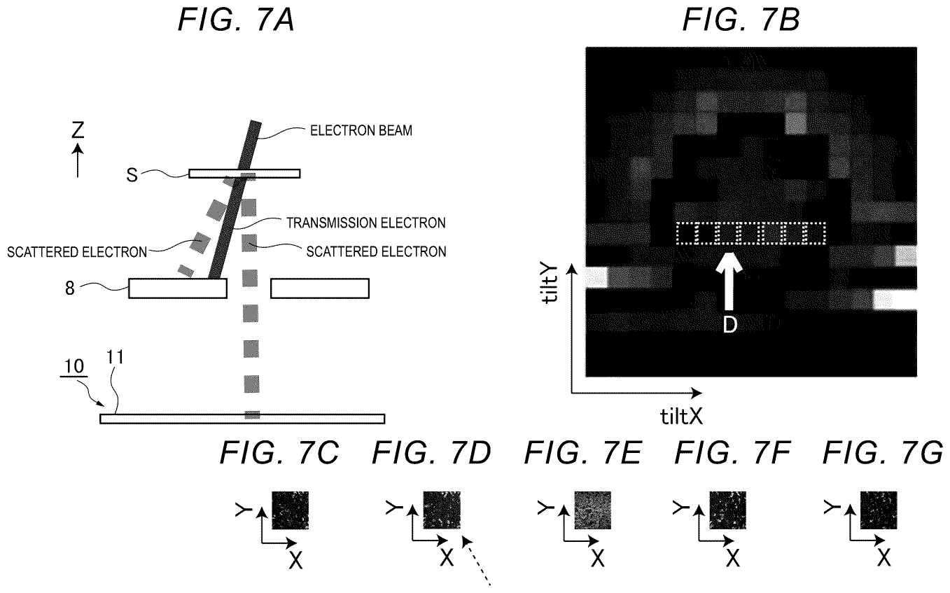

In addition, for example, as shown in FIG. 7A, a case where the irradiation unit 2 and the aperture unit 8 are controlled to change the incident angle of the electron beam e, the electron beam e transmitted from the sample S is shielded by the aperture unit 8, and the electron beam e scattered by the sample S is imaged is considered. The captured image in this case is a dark-field image (DF image) shown in FIG. 7D.

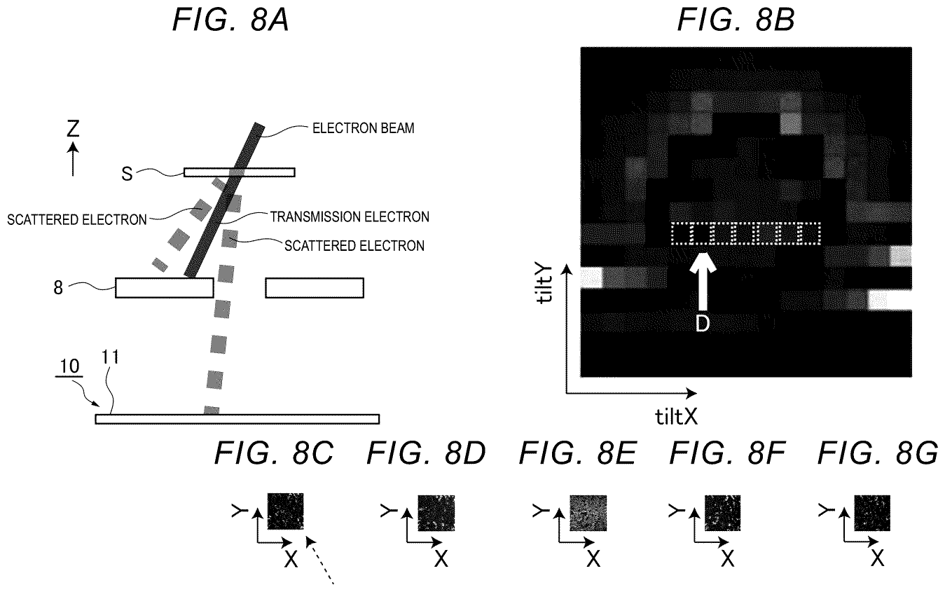

In addition, for example, as shown in FIG. 8A, a case where the irradiation unit 2 and the aperture unit 8 are controlled to change the incident angle of the electron beam e, the electron beam e transmitted from the sample S is shielded by the aperture unit 8, and the electron beam e scattered by the sample S is imaged is considered. The captured image in this case is a dark-field image (DF image) shown in FIG. 8C.

It is preferable that the analysis unit 14 performs analysis using the electron beam intensity in each of a plurality of images including a bright-field image (BF image) or a dark-field image (DF image) obtained by using a plurality of incident angles. The example will be described below.

It is preferable that the analysis unit 14 analyzes the sample based on data D in which the electron beam intensity of the bright-field image or the dark-field image is plotted with a first angle (an example of ex or tilt X) of a plurality of incident angles, as a first axis, in a first direction (an example of the X direction) parallel to the imaging surface and a second angle (an example of θy or tilt Y) of the incident angles, as a second axis, in a second direction intersecting the first direction and parallel to the imaging surface, for example, for the bright-field image or the dark-field image obtained for one incident angle of the incident angles.

For example, FIGS. 4A, 5A, 6A, 7A, and 8A show the bright-field image (BF image) and the dark-field image (DF image) acquired when the tilt X value is changed while the tilt Y value is kept constant for the incident angle of the electron beam e. FIGS. 4B, 5B, 6B, 7B, and 8B show a summary of the data D in which the electron beam intensity of the bright-field image or the dark-field image is plotted for tilt X and tilt Y. The data D plotted in correspondence to each of the tilt X and the tilt Y is shown using the white arrows shown in each of the drawings. It is preferable that the plot of the electron beam intensity is performed by processing the electron beam intensity of the bright-field image or the dark-field image within a range larger than 3 nm square and smaller than 10 μm square. When the range is 3 nm square or smaller, the range is too small, and a variation in the electron beam intensity is large, so that stable analysis cannot be performed. On the other hand, when the range is 10 μm square or more, the range is too large, and a plurality of crystal grains and amorphous portions are mixed, so that valid analysis results cannot be obtained. Here, the “processing” is, for example, an integration processing of an electron beam intensity within a range larger than 3 nm square and smaller than 10 μm square. However, the “processing” here is not limited to the integration processing.

In FIGS. 4B, 5B, 6B, 7B, and 8B, the positions of the data obtained by acquiring the bright-field image (BF image) and the dark-field image (DF image) with reference to FIGS. 4A, 5A, 6A, 7A, and 8A are changed by white arrows.

The electron beam intensity is indicated by color. When the number of portions that are white is large, it indicates that the electron beam intensity is strong. When the number of portions that are black is large, it indicates that the electron beam intensity is low.

The data shown in FIGS. 4B, 5B, 6B, 7B, and 8B can be obtained by changing tilt X and tilt Y.

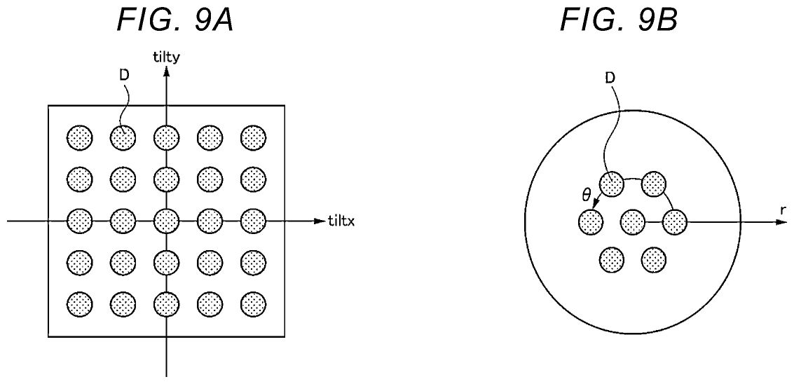

FIGS. 9A and 9B are schematic diagrams showing another example of the sample analysis method using the transmission electron microscope 100 according to the embodiment. Here, the sample analysis method shown in FIG. 9A corresponds to, for example, the example of the sample analysis method described with reference to FIGS. 4A to 8G. The sample analysis method shown in FIG. 9B is a sample analysis method in which the data D of the electron beam intensity is plotted at a distance (r) from the center on the sample S and an angle (θ) from a predetermined direction parallel to the XY plane. Both sample analysis methods can be preferably used. In addition, other methods may also be used.

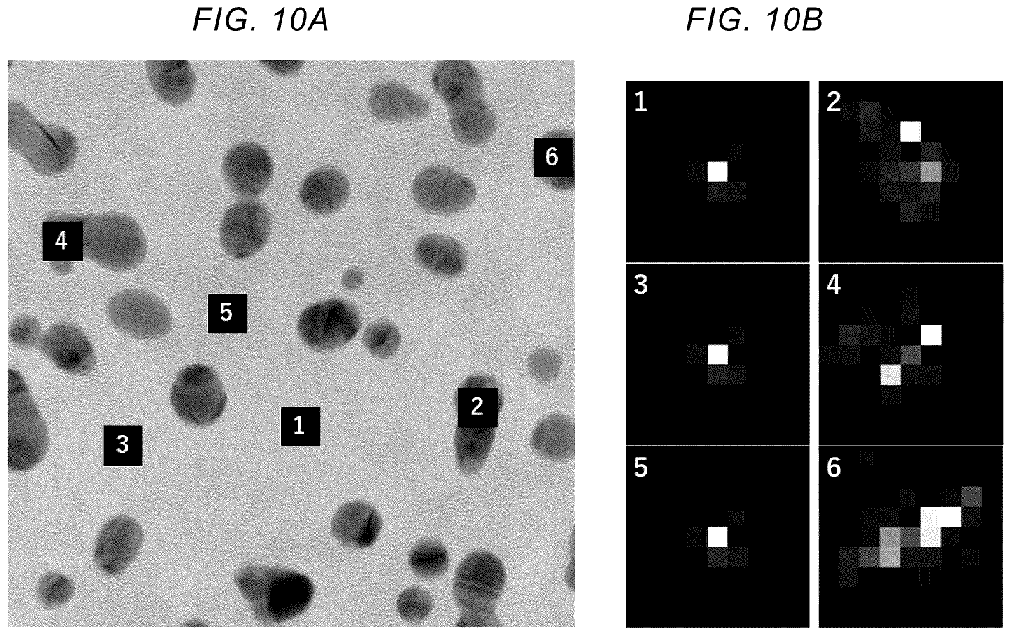

FIGS. 10A and 10B are schematic diagrams showing another example of the sample analysis method using the transmission electron microscope 100 according to the embodiment. The analysis unit 14 classifies the sample S as a crystal, an amorphous body, or a crystal grain based on the data. FIG. 10A is an example of a transmission electron microscope image of the sample S. The regions 1, 3, and 5 are amorphous regions. The regions 2, 4, and 6 are crystal grain portions. FIG. 10B shows the data D in which the electron beam intensity of the bright-field image or the dark-field image is plotted with the first angle (an example of ex or tilt X) of the incident angle, as a first axis, in the first direction (an example of the X direction) parallel to the imaging surface and the second angle (an example of θy or tilt Y) of the incident angle, as a second axis, in the second direction intersecting the first direction and parallel to the imaging surface, and that corresponds to each region shown in FIG. 10A. In the regions 1, 3, and 5, all centers have the maximum intensity. In contrast, in the regions 2, 4, and 6, a portion having a high intensity is observed in a portion other than the center. In this way, it is possible to classify the sample S as a crystal, an amorphous body, or a crystal grain.

The analysis performed by the analysis unit 14 is not limited to the above.

In addition, it is also preferable that the control unit 12 performs hollow cone irradiation of the electron beam e using the irradiation unit 2. In the hollow cone irradiation, the sample S is irradiated with the electron beam e, which is patterned in a hollow cone. In this case, it is possible to reduce the influence of inelastic scattering, which causes blurring and a decrease in contrast of the captured image. In addition, since the electrons having a small scattering angle are excluded, a multiple scattering effect that degrades the image captured can be prevented. In the hollow cone irradiation, the acquisition of the bright-field image and the analysis based on the bright-field image are not required.

Next, the action and effect of the transmission electron microscope of the embodiment will be described.

For example, in the analysis using the nano-beam diffraction (NBD) method, since the electron beam needs to be condensed on a micro region on the sample S for measurement, the measurement range is narrow and the measurement takes time.

In contrast, in the analysis using the transmission electron microscope according to the embodiment, the electron beam is emitted over a wide region on the sample S and the measurement at various angles can be performed, so that the measurement range is wide and the measurement time is short.

According to the transmission electron microscope and the sample analysis method using the transmission electron microscope of the embodiment, it is possible to provide the transmission electron microscope and the sample analysis method using the transmission electron microscope, which can analyze a sample over a wide range and with high resolution.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A transmission electron microscope comprising:
an irradiation unit configured to irradiate a sample using a parallel electron beam at a predetermined incident angle;
a sample holder configured to hold the sample;
an aperture unit located downstream in a traveling direction of the electron beam transmitted the sample or scattered by the sample, and that has an opening;
an image forming lens located downstream in the traveling direction of the electron beam relative to the opening of the aperture unit, and configured to form an image of the electron beam selected by the aperture unit;
an image capturing unit that is located downstream in the traveling direction of the electron beam relative to the image forming lens, and configured to capture a bright-field image and a dark-field image formed by the image forming lens, the image capturing unit having an imaging surface; and
an analyzer that analyzes the sample based on the bright-field image and the dark-field image.

2. The transmission electron microscope according to claim 1, wherein the analyzer is configured to perform analysis using an electron beam intensity in each of a plurality of images including the bright-field image or the dark-field image obtained by using a plurality of the incident angles.

3. The transmission electron microscope according to claim 1, wherein the analyzer is configured to analyze the sample based on data in which an electron beam intensity of the bright-field image or the dark-field image is plotted with a first angle of a plurality of the incident angles, as a first axis, in a first direction parallel to the imaging surface and a second angle of the incident angles, as a second axis, in a second direction intersecting the first direction and parallel to the imaging surface, for the bright-field image or the dark-field image obtained for one incident angle among the incident angles.

4. The transmission electron microscope according to claim 3, wherein the analyzer is configured to process the electron beam intensity of the bright-field image or the dark-field image within a range larger than 3 nm square and smaller than 10 μm square to plot the electron beam intensity.

5. The transmission electron microscope according to claim 3, wherein the analyzer is configured to classify the sample as a crystal, an amorphous body, or a crystal grain based on the data.

6. The transmission electron microscope of claim 1, further comprising a control circuit configured to control the focus of the bright-field image and the dark-field image by controlling an excitation amount of an objective lens.

7. The transmission electron microscope of claim 6, wherein the control circuit is further configured to control a size of the opening.

8. The transmission electron microscope of claim 1, wherein the aperture unit has a thickness configured to shield the electron beam in the travelling direction.

9. The transmission electron microscope of claim 8, wherein selecting the electron beam includes allowing one of the electron beam transmitted from the sample or scattered by the sample through the opening.

10. A sample analysis method using a transmission electron microscope, the method comprising:
irradiating a sample using a parallel electron beam at a predetermined incident angle;
forming an image, by an image forming lens, based on the electron beam selected by an aperture unit, the aperture unit being located downstream in a traveling direction of the electron beam transmitted from the sample or scattered by the sample and including an opening;
capturing, using an image capturing unit, a bright-field image and a dark-field image formed by the image forming lens; and
analyzing the sample based on the bright-field image and the dark-field image.

11. The sample analysis method of claim 10, further comprising:
setting an irradiation point of the electron beam on the sample at which to irradiate the sample;
wherein the irradiation point is defined by an X coordinate and a Y coordinate.

12. The sample analysis method of claim 11, wherein the bright field image and the dark-field image include one or more bright-field images and one or more dark-field images acquired at the irradiation point based on a plurality of irradiation angles.

13. The sample analysis method of claim 11, further comprising:
changing the irradiation point of the electron beam on the sample to irradiate the sample at a plurality of irradiation points.

14. The sample analysis method of claim 13, wherein the bright field image and the dark-field image include a plurality of bright-field images and a plurality of dark-field images associated with the plurality of irradiation points.

15. The sample analysis method of claim 10, wherein the sample is irradiated with the electron beam patterned in a hollow cone.
